(19) United States
(12) Patent Application Publication
(10) Pub. No.: US 2018/0060753 A1
(43) Pub. Date: Mar. 1, 2018

(54) ESTIMATION OF REACH OVERLAP AND UNIQUE REACH FOR DELIVERY OF CONTENT ITEMS

(71) Applicant: Facebook, Inc., Menlo Park, CA (US)

(72) Inventors: Liang Xu, Bellevue, WA (US); Chaochao Cai, Bellevue, WA (US); Goran Predovic, Redmond, WA (US)

(21) Appl. No.: 15/250,452

(22) Filed: Aug. 29, 2016

(51) Int. Cl. G06N 99/00; H04L 29/08

(52) U.S. Cl. CPC G06N 99/005; H04L 67/10

(57) ABSTRACT

An online system obtains a set of resolved impressions based on historical data about multiple publishers. A set of features is then extracted, for each resolved impression, based on a comparison of historical data about the first publisher and the second publisher. The online system performs training of a machine-learned model based on the set of features. Data about a plurality of new impressions are input into the trained machine-learned model to obtain an output of the trained machine-learned model. A reach overlap metric and unique reach metric can be computed based on the output of the trained machine-learned model.

### BACKGROUND

This disclosure relates generally to delivering content items across multiple publishers, and more specifically to estimating unique reach and reach overlap metrics when delivering content items to multiple publishers.

An online system, such as a social networking system, allows its users to connect to and communicate with other online system users. Users may create profiles on an online system that are tied to their identities and include information about the users, such as interests and demographic information. The users may be individuals or entities such as corporations or charities. Because of the increasing popularity of online systems and the increasing amount of user-specific information maintained by online systems, an online system provides an ideal forum for entities to increase awareness about products or services by presenting content items to online system users.

Online services, such as social networking systems, search engines, news aggregators, Internet shopping services, and content delivery services, have become a popular venue for presenting content items. A content item includes any kind of content that can be presented online. A content provider is an entity that provides content items to one or more publishers for presentation to online users. A publisher is an entity that actually presents or displays content items to online users or viewers. The display of a content item to an online viewer via a publisher is referred to herein as an “impression.” Some publishers provide their services free of charge or charge certain fees. The content item-based online service model has spawned many diverse types of online services.

Content providers may wish to know which publishers show their content. In particular, providers of content items may wish to know which publishers show content items to users who do not see that content items on other publishing sites. A content provider is therefore interested in reach metrics related to multiple publishers that present content items. Unique reach for a given publisher represents a metric that indicates an estimated number of reached users that viewed certain content item(s) only on that one publisher. A reach overlap metric indicates an estimated number of users that viewed the content item(s) on multiple publishers, i.e., the reach overlap metric represents an estimated overlapped audience among multiple publishers. The unique reach and reach overlap metrics can be utilized by a content provider to optimize delivery of content items to online users. If, for example, most users reached by a publisher can already be reached by another publisher, then a marketing value of the publisher is low as the unique reach metric of the publisher is small and an amount of overlapped audience is large. Content providers typically search for efficient publishers that can bring a large unique reach metric, i.e., a large amount of non-overlapped audience. Thus, accurate estimation of the unique reach and reach overlap metrics is desired.

### SUMMARY

An online system, such as a social networking system, computes various metrics for delivery of content items across multiple publishers, such as unique reach and reach overlap. Unique reach indicates an estimated number of online system users who saw a content item one or more times via only one publisher. Reach overlap indicates an estimated number of online system users who saw a content item one or more times via two different publishers, i.e., an audience overlap between two publishers. The online system uses a reach prediction (estimation) model that predicts reach of each publisher and a combined reach on both publishers to compute the reach overlap between two publishers.

Unique reach and reach overlap can be also estimated based on a machine-learned model that can directly estimate unique reach metric for a given publisher. The machine-learned model for estimation of the unique reach can be trained based on training data related to a set of impressions obtained from historical data using publishers' identity information and users' identity information maintained by the online system. The identity information related to the set of impressions can be tracked using, for example, logged-in cookies for the online system. The trained machine-learned model estimates the unique reach metric for a given publisher based on inputting into the trained machine-learned model data related to a plurality of impressions.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 is a flowchart of a method for estimating reach overlap between two different publishers, in accordance with an embodiment.

FIG. 4 illustrates an example graph showing reach metrics for multiple publishers that may have intersecting domains, in accordance with an embodiment.

FIG. 5 illustrates a process flow diagram of building a machine-learned model for estimating unique reach and reach overlap metrics when delivering content items to online users, in accordance with an embodiment.

FIG. 6 is a flowchart of a method for estimating unique reach and reach overlap metrics when delivering content items to online users based on the machine-learned model shown in FIG. 4, in accordance with an embodiment.

FIGS. 7A and 7B are graphs showing performance of different models for estimation of unique reach and reach overlap metrics, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

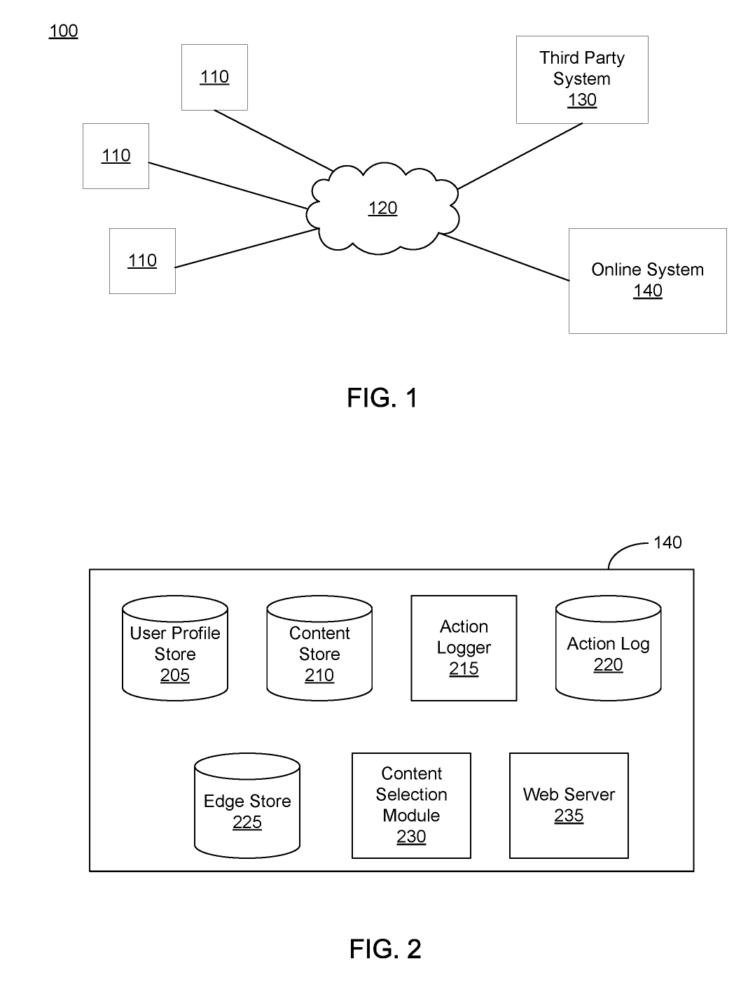

FIG. 1 is a block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100. The embodiments described herein may be adapted to online systems that are social networking systems, content sharing networks, or other systems providing content items to users.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone, a smartwatch or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device 110. In other embodiments, a third party system 130 provides content or other information for presentation via a client device 110. A third party system 130 may also communicate information to the online system 140, such as content items, content, or information about an application provided by the third party system 130.

In some embodiments, one or more of the third party systems 130 provide content items to the online system 140 for presentation to users of the online system 140. A content item includes any kind of content that can be presented online. In an embodiment, a third party system 130 may provide compensation to the online system 140 in exchange for presenting a content item. Content presented by the online system 140 for which the online system 140 receives compensation in exchange for presenting is referred to herein as “sponsored content,” or “sponsored content items.” Sponsored content from a third party system 130 may be associated with the third party system 130 or with another entity on whose behalf the third party system 130 operates.

FIG. 2 is a block diagram of an architecture of the online system 140. The online system 140 shown in FIG. 2 includes a user profile store 205, a content store 210, an action logger 215, an action log 220, an edge store 225, a content selection module 230, and a web server 235. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the online system users displayed in an image, with information identifying the images in which a user is tagged and stored in the user profile of the user. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity. In some embodiments, the brand page associated with the entity's user profile may retrieve information from one or more user profiles associated with users who have interacted with the brand page or with other content associated with the entity, allowing the brand page to include information personalized to a user when presented to the user.

The content store 210 stores objects that each represents various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a client device 110, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), engaging in a transaction, viewing an object (e.g., a content item), and sharing an object (e.g., a content item) with another user. Additionally, the action log 220 may record a user's interactions with content items on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce web sites, such as in the preceding example, may communicate information about a user's actions outside of the online system 140 to the online system 140 for association with the user. Hence, the action log 220 may record information about actions users perform on a third party system 130, including webpage viewing histories, content items that were engaged, purchases made, and other patterns from shopping and buying. Additionally, actions a user performs via an application associated with a third party system 130 and executing on a client device 110 may be communicated to the action logger 215 by the application for recordation and association with the user in the action log 220.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

In one embodiment, an edge may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or a particular user. For example, a feature may represent the level of interest that a user has in a particular topic, the rate at which the user logs into the online system 140, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate the user's interest in an object, in a topic, or in another user in the online system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The content selection module 230 selects one or more content items for communication to a client device 110 to be presented to a user. Content items eligible for presentation to the user are retrieved from the content store 210, or from another source by the content selection module 230, which selects one or more of the content items for presentation to the user. A content item eligible for presentation to the user is a content item associated with at least a threshold number of targeting criteria satisfied by characteristics of the user or is a content item that is not associated with targeting criteria. In various embodiments, the content selection module 230 includes content items eligible for presentation to the user in one or more selection processes, which identify a set of content items for presentation to the user. For example, the content selection module 230 determines measures of relevance of various content items to the user based on characteristics associated with the user by the online system 140 and based on the user's affinity for different content items. Information associated with the user included in the user profile store 205, in the action log 220, and in the edge store 225 may be used to determine the measures of relevance. Based on the measures of relevance, the content selection module 230 selects content items for presentation to the user. As an additional example, the content selection module 230 selects content items having the highest measures of relevance or having at least a threshold measure of relevance for presentation to the user. Alternatively, the content selection module 230 ranks content items based on their associated measures of relevance and selects content items having the highest positions in the ranking or having at least a threshold position in the ranking for presentation to the user.

Content items selected for presentation to the user may include sponsored content items associated with bid amounts. The content selection module 230 uses the bid amounts associated with content items when selecting content for presentation to the viewing user. In various embodiments, the content selection module 230 determines an expected value associated with various sponsored content items based on their bid amounts and selects sponsored content items associated with a maximum expected value or associated with at least a threshold expected value for presentation. An expected value associated with a content item represents an expected amount of compensation to the online system 140 for presenting the content item. For example, the expected value associated with a content item is a product of the content item's bid amount and a likelihood of the user interacting with the content from the content item. The content selection module 230 may rank sponsored content items based on their associated bid amounts and select sponsored content items having at least a threshold position in the ranking for presentation to the user. In some embodiments, the content selection module 230 ranks both content items not associated with bid amounts and sponsored content items in a unified ranking based on bid amounts associated with sponsored content items and measures of relevance associated with content items. Based on the unified ranking, the content selection module 230 selects content for presentation to the user. Selecting content items through a unified ranking is further described in U.S. patent application Ser. No. 13/545,266, filed on Jul. 10, 2012, which is hereby incorporated by reference in its entirety.

The web server 235 links the online system 140 via the network 120 to the one or more client devices 110, as well as to the one or more third party systems 130. The web server 235 serves web pages, as well as other content, such as JAVA®, FLASH®, XML and so forth. The web server 235 may receive and route messages between the online system 140 and the client device 110, for example, instant messages, queued messages (e.g., email), text messages, short message service (SMS) messages, or messages sent using any other suitable messaging technique. A user may send a request to the web server 235 to upload information (e.g., images or videos) that are stored in the content store 210. Additionally, the web server 235 may provide application programming interface (API) functionality to send data directly to native client device operating systems, such as IOS®, ANDROID™, WEBOS® or BlackberryOS.

### Estimation of Reach Overlap for Delivery of Content Items to Multiple Publishers

When delivering content items on two different online systems, or publishers, several metrics can be of importance for a content provider delivering the content items, such as metrics related to reach and frequency. The reach is a total number of online system users who saw a content item one or more times, i.e., a total number of unique impressions. The frequency is a total number of impressions divided by a total number of unique impressions, i.e., users who saw a content item saw the content item on average the frequency number of times. A publisher may include a desktop web site, a mobile web site, a mobile/native application, a desktop application, and any domain that can provide content to a user from an online content source. A publisher can further represent a type of client device 110 (e.g., desktop, mobile, etc.) on which one or more content items can be accessed by online system users. Described embodiments include methods for estimation of unique reach metric and reach overlap metric associated with delivery of content items to online system users by multiple publishers. Delivery of content items by multiple publishers can be reduced herein to delivery of content items by two different publishers. The unique reach metric and reach overlap metric can be estimated for a given first publisher by grouping together all the rest of the publishers and treating them as a second publisher. The estimation methods presented herein can be implemented into the online system 140 that delivers content items for presentation to online system users.

Unique reach represents a metric that indicates an estimated number of online system users who saw a content item one or more times via only one publisher. Reach overlap represents a metric that indicates an estimated number of online system users who saw a content item one or more times via two different publishers. In other words, the reach overlap represents an audience overlap between two publishers.

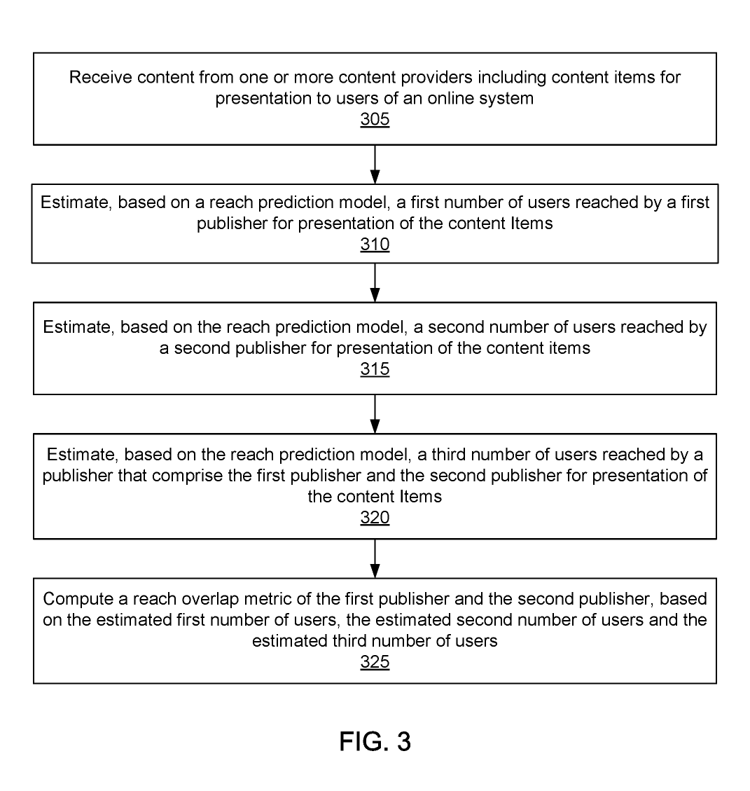

FIG. 3 is a flowchart of one embodiment of a method for estimation of reach overlap between two different publishers, in accordance with an embodiment. In various embodiments, the steps described in conjunction with FIG. 3 may be performed in different orders than the order described in conjunction with FIG. 3. Additionally, the method may include different and/or additional steps than those described in conjunction with FIG. 3 in some embodiments.

The online system 140 receives 305 content from one or more content providers including one or more content items for presentation to one or more users of the online system 140. In various embodiments, the online system 140 computes metrics for delivery of content items across multiple publishers, including reach metric. An overlap in reach occurs when same online system users can access a content item through two different publishers. To provide a metric indicating the reach overlap of a publisher, the online system 140 employs a reach prediction model that estimates reach of each publisher as well as reach of both publishers, which can be used to obtain reach overlap. Described embodiments further include methods for building a model that directly predicts a percentage of unique reach for any publisher. The online system 140 can apply this model to compute at least one of unique reach or reach overlap for a given publisher.

In some embodiments, the reach prediction model can be applied by the online system 140 to estimate 310 and 315 reach across different publishers, i.e., to estimate 310 reach for a first publisher and to estimate 315 reach for a second publisher different from the first publisher. The reach prediction model can be also applied by the online system 140 to estimate 320 an overall reach for different publishers, i.e., a number of online system users who saw a content item one or more times via a publisher that comprises and combines the first publisher and the second publisher. The reach estimated 310 and 315 for each publisher and the reach estimated 320 for combined publishers represent reach metrics that may be utilized by one or more content providers for evaluation of the publishers. In some embodiments, as discussed in more detail below, reach overlap between two different publishers can be computed 325 based on the reach estimated 310 for the first publisher, the reach estimated 315 for the second publisher and the combined reach estimated 320 for the publisher that combines the first and the second publishers.

In some embodiments, as discussed, the reach overlap metric computed 325 indicates an overlap in audience across different publishers, i.e., an estimated number of common users that have an access to a particular content item or a group of content items on both publishers. Alternatively, or in addition to, the reach overlap metric computed 325 can be estimated in relation to a type of client device 110 or platform (e.g., desktop, mobile, etc.) on which content item or a group of content items can be accessed by online system users, whereas a single publisher can deliver the content item or the group of content items to the online system users on different types of client devices 110 or platforms. In this case, reach of a client device 110 or platform of a first type (e.g., mobile device) estimated 310 indicates an estimated number of online system users reached for delivery of a content item or a group of content items on the client device 110 or a platform of the first type. Similarly, reach of a client device 110 or a platform of a second type (e.g., desktop device) estimated 315 indicates an estimated number of online system users reached for delivery of a content item or a group of content items on the client device 110 or platform of the second type. Combined reach of a client device 110 or a platform of a type that comprises the first type and the second type (e.g., desktop and mobile devices) estimated 320 indicates an estimated number of online system users reached for delivery of a content item or a group of content items on the client device 110 or platform of the combined type. Then, the reach overlap metric computed 325 indicates an estimated number of common users reached for delivery and presentation of a content item or a group of content items on client devices 110 or platforms of both the first type and the second type.

Estimations 310, 315, 320 of reach metrics and computation 325 of reach overlap metric is based on estimation of a number of online system users who saw a content item or a group of content items provided by a content provider via a publisher. Thus, certain distribution of error can be introduced when estimating the reach metrics and the reach overlap metric.

In some embodiments, a method for obtaining 325 the reach overlap can be based on estimation 320 of reach combined (i.e., overall reach for combined publishers) and estimations 310, 315 of separate reaches for individual publishers (i.e., estimation 310 of a separate reach for a first publisher and estimation 315 of a separate reach for a second publisher different from the first publisher). The reach for the first publisher can be estimated 310 based on the reach prediction model applied in isolation for the first publisher; similarly, the reach for the second publisher can be estimated 315 based on the reach prediction model applied in isolation for the second publisher. To obtain 325 an estimate of the reach overlap, the combined reach estimated 320 can be subtracted from a sum of the separate reaches estimated 310, 315 in isolation for the first publisher and for the second publisher.

In various embodiments, a content provider can select the first publisher or the second publisher for presentation of one or more content items, based at least in part on the estimated number of common users, i.e., based at least in part on the reach overlap obtained 325. In some embodiments, the unique reach for the first publisher can be obtained by subtracting the number of common users estimated 325 from the reach for the first publisher estimated 310. The unique reach for the second publisher can be obtained by subtracting the number of common users estimated 325 from the reach for the second publisher estimated 310. The content provider selects the first publisher or the second publisher for presentation of one or more content items based on the unique reach for the first publisher and the unique reach for the second publisher. In an embodiment, the content provider selects the first publisher for presentation of one or more content items if the unique reach for the first publisher is greater than the unique reach for the second publisher. In another embodiment, the content provider selects the second publisher for presentation of one or more content items if the unique reach for the second publisher is greater than the unique reach for the first publisher.

The traditional production model may derive the unique reach metric by applying the following method. Given a first publisher (e.g., publisher A) and a second publisher (e.g., publisher B) for delivering one or more content items provided by a content provider, the unique reach of the first publisher, i.e., Reach(A/B), can be obtained as:

Reach(A/B)=Reach(A)−Reach (both A and B)/min{match rate(A), match rate (B)}, (1)

where Reach (A) is a total reach or match rate of the first publisher, Reach (both A and B) is a reach of combined first and second publishers, match rate (A) is a reach or a match rate of the first publisher, and match rate (B) is a reach or a match rate of the second publisher. The model for estimation of unique reach defined by equation (1) can be applied to any publisher. However, the model for estimation of unique reach defined by equation (1) can introduce inconsistency when reach overlap of the first and second publishers is large.

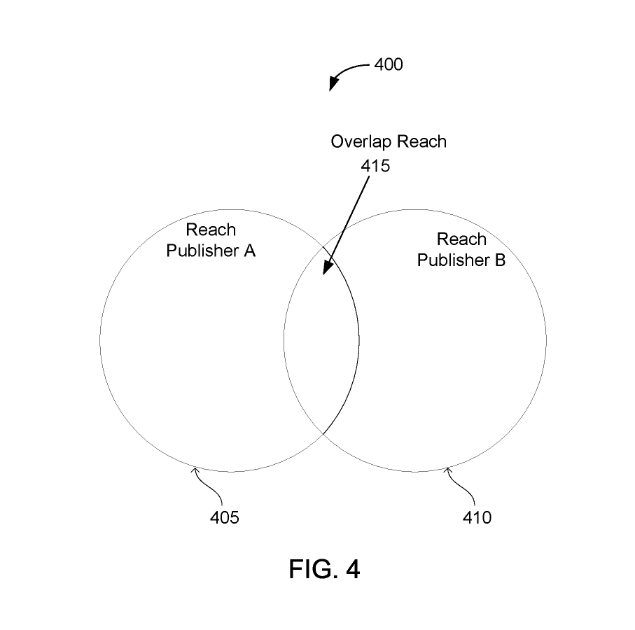

Described embodiments include methods for generating more accurate models for computation of the reach overlap metric and the unique reach metric for a given publisher. FIG. 4 illustrates an example graph 400 showing reaches for two different publishers with intersecting domains, in accordance with an embodiment. A set 405 represents visualization of a total reach of a first publisher (e.g., publisher A), which is estimated 310 based on the reach prediction model applied to the first publisher; similarly, a set 410 represents visualization of a total reach of a second publisher (e.g., publisher B) different from the first publisher, which is estimated 315 based on the reach prediction model applied to the second publisher. In various embodiments, the second publisher may comprise all publishers different from the first publisher. Intersection 415 shown in FIG. 4 represents visualization of the reach overlap that is computed 325, i.e., an estimated number of common online system users reached for viewing/accessing content item(s) via both the first publisher and the second publisher. Therefore, in some embodiments, the reach overlap can be computed 325 as an intersection of two sets, i.e.,

Overlap=A∩B=A+B−A∪B, (2)

where A is a total reach of the first publisher that is estimated 310 based on the reach prediction model applied for the first publisher; B is a total reach of the second publisher that is estimated 315 based on the reach prediction model applied for the second publisher; and A∪B represents a union of reach domains of the first and second publishers, i.e., reach for combined first and second publishers that is estimated 320 based on the reach prediction model applied for the combined publisher. In various embodiments, the same reach prediction model can be applied across different publishers. Therefore, the reach for combined first and second publishers can be estimated 320 by applying the same reach prediction model when the first and second publishers are considered as a single combined publisher. The value of reach overlap as defined by equation (2) can be obtained for any pairs of different publishers, and reported to one or more content providers.

### Model for Predicting Percentage of Unique Reach

In some embodiments, as discussed, a content provider is interested in various reach metrics related to multiple publishers, in particular to unique reach and reach overlap metrics. Unique reach for a given publisher represents a metric that indicates an estimated number of online system users that are able to access or view a particular content item or a group of content items only on that one publisher during a certain time period. The reach overlap indicates an estimated number of online system users that can view/access a particular content item or a group of content items on both publishers, i.e., an overlap audience between two publishers. The unique reach and reach overlap metrics can be used by the content provider to optimize delivery of content items. For example, if most users reached by a publisher can already be reached by another publisher, then a marketing value of the publisher is low since the unique reach of the publisher is small and the reach overlap is large. The content provider searches for efficient publishers that can bring a large unique reach during a defined time period. Thus, the content provider looks into the unique reach and the reach overlap to get insight into what are the most valuable publishers for delivering content items to new users.

Disclosed embodiments include methods for decoupling of measuring the accuracy of reach metric and the accuracy of reach and overlap (“reach overlap”) metric. Estimation accuracy of the reach and reach overlap metrics is based on accuracy of predicting a percentage of unique reach, which is discussed in more detail below. In some embodiments, the unique reach can be derived from the percentage of unique reach and the overall reach of a publisher estimated based on the aforementioned reach prediction model. The reach overlap can be then obtained based on the derived unique reach metric. Thus, estimation of the reach and of the reach overlap can be de-coupled by treating reach overlap as a two-step model. The benefit of this approach is to ensure consistency between the reach metric and the reach overlap metric.

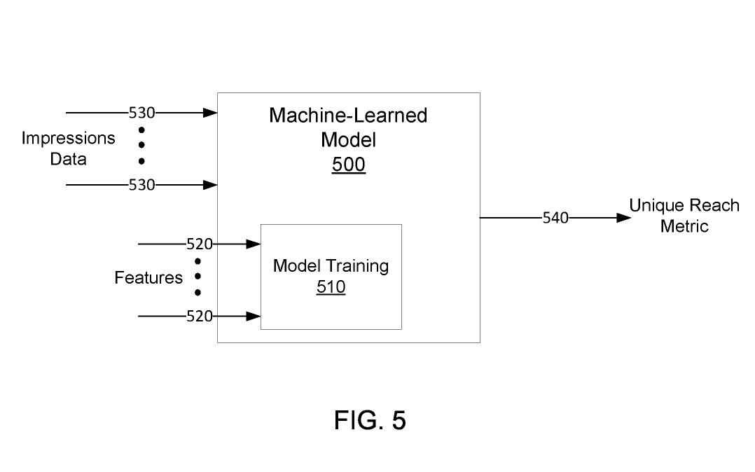

FIG. 5 illustrates a process flow diagram of building a machine-learned model 500 for predicting a percentage of unique reach for a given publisher, in accordance with an embodiment. In various embodiments, the machine-learned model 500 may be an integral part of the online system 140, and the online system 140 can be configured to build the machine-learned model 500. In some embodiments, the online system 140 may employ the machine-learned model 500 presented herein to estimate a percentage of unique reach for a given publisher, and the machine-learned model 500 can be applied across different publishers. The machine-learned model 500 can be built based on model training 510 performed on a set of features 520 related to a training set of impressions. The machine-learned model 500 predicts, based on data 530 related to a plurality of impressions related to displaying content via one or more publishers, unique reach metric 540 for a given publisher. In an embodiment, the unique reach metric 540 is based on a percentage of online system users that saw the content via only a first publisher.

Disclosed embodiments include methods for generating the machine-learned model 500 that directly predicts (estimates) a percentage of unique reach for a given publisher based on impressions data 530 and the training method 510. The machine-learned model 500 presented herein can be also referred to as a percentage model. In some embodiments, the machine-learned model 500 can be trained 510 based on the linear regression method or some other regression methods. The trained machine-learned model 500 may provide as the output 540 an estimated percentage of online system users reached only by one publisher, which further provides an estimate of unique reach metric for that publisher.

In some embodiments, the unique reach metric for a given publisher can be estimated based on the machine-learned model 500 that provides as the output 540 a percentage of online system users uniquely reached for accessing/viewing the content only by that one publisher. Estimation of a number of unique online system users reached only by one publisher is then averaged. The percentage 540 of unique online system users reached only by the first publisher is multiplied with an estimated total number of online system users reached by the first publisher (i.e., reach of the first publisher) to obtain an estimated number of unique online system users reached only by the first publisher, i.e.,

Unique Reach (A/B)=Percentage Model (A/B)*Reach (A), (3)

where Unique Reach (A/B) is a unique reach metric that indicates an estimated number of online system users that accessed/viewed the content only via a first publisher (e.g., publisher A) and that could not view/access the content via a second publisher (e.g., publisher B), Percentage Model (A/B) is the output 540 obtained by applying the machine-learned model 500 and represents an estimated percentage of online system users that accessed/viewed the content only via the first publisher, and Reach (A) is a total reach of the first publisher that can be estimated as the reach metric based on the aforementioned reach prediction model. In some embodiments, the value of Unique Reach (A/B) as defined by equation (3) can be obtained for different publishers, and reported to one or more content providers.

In some embodiments, the unique reach for a given publisher obtained in accordance with equation (3) can be utilized to estimate reach overlap between two different publishers. As illustrated in FIG. 4, the set 405 represents a total reach of a first publisher estimated using the reach prediction model; similarly, the set 410 represents a total reach of a second publisher estimated using the reach prediction model; and the intersection area 415 represents the reach overlap between two different publishers. Thus, the reach overlap can be obtained by subtracting the unique reach (i.e., area 405 without the intersection area 415) from total reach of first publisher (i.e., the area 405). Based on equation (3), the reach overlap can be determined as:

Reach Overlap (A, B)=Reach (A)−Percentage Model (A/B)*Reach (A). (4)

In accordance with equation (4), the reach overlap between two publishers can be obtained based on the reach metric obtained based on the reach prediction model and the percentage 540 of unique reach obtained by applying the machine-learned model 500.

In some embodiments, the machine-learned model 500 that provides an estimate of percentage of unique online system users reached only by one publisher can be built based on multiple components. One component for building the machine-learned model 500 can be related to features 520 input into the machine-learned model 500 that are used for training 510 of the machine-learned model 500. Another component for building the machine-learned model 500 is related to model training 510. In an embodiment, the model training 510 can be applied based on a ground truth to achieve accurate prediction of the percentage of unique reach.

Certain input features 520 used for building the machine-learned model 500 can be the same as features used for building the aforementioned reach prediction model. Certain other features 520 used for building the machine-learned model 500 can be different and directed to users' aggregation data, a percentage of unique Internet Protocol (IP) addresses reached by a publisher, comparisons between publishers such as cookie overlapping between the publishers, etc. In some embodiments, the features 520 can be related to some aggregated statistics on a set of impressions, statistics of different online system users of the first publisher and the second publisher, different cookies between the publishers, etc. Some of the features 520 are based on a percentage of distinct IP addresses of users reached by the first publisher and by the second publisher, a percentage of same IP addresses of users that are reached by both the first and the second publisher, a percentage of cookie overlaps in reach domains of both publishers. In some embodiments, the features 520 represent training inputs into the machine-learned model 500 that can be trained 510 based on the linear regression algorithm or some other regression technique(s). An output 540 of the trained machine-learned model 500 is a percentage of unique reach obtained based on data 530 related to a plurality of impressions for delivery of content items, i.e., a percentage of unique online system users that viewed/accessed the content items only via a single publisher.

In various embodiments, the model training 510 of the machine-learned model 500 is based on the simulated ground truth that is generated from fitting data. In some embodiments, to obtain the ground truth, all unresolved impressions can be excluded from consideration. In an embodiment, any impression without identity of a particular publisher, i.e., any unresolved impression, can be excluded from the fitting data. A resolved impression for a given publisher represents a display of a content item to an online viewer with a known identity via that publisher. The online system 140 has the knowledge about an identity of the online viewer based on matching a cookie (e.g., a logged cookie) associated with that particular impression with a known identification of the online viewer on that publisher. A set of impressions used for the model training may contain only publisher-matched impressions, i.e., the set of impressions is completely resolved and comprises only resolved impressions. Therefore, any metric associated with the set of resolved impressions can be accurately computed, which represents a ground truth for the model training 510 of the machine-learned model 500.

To avoid bias, obtaining the set of completely resolved impressions can be performed by the online system 140 across many publishers. Furthermore, certain regression techniques can be included into the model training 510 to minimize bias as much as possible. In some embodiments, only features that are stable between original data and simulated data are selected for the model training 510. Features that would be biased for a particular simulation technique applied for the model training 510 are not utilized.

In some embodiments, several operations are performed for the model training 510 of the machine-learned model 500. First, a set of training impressions is obtained (received) that have an identification of a given publisher, i.e., a set of resolved impressions is utilized which provides a ground truth for training 510 of the machine-learned model 500. Second, de-synchronization of the set of resolved impressions can be performed to simulate a match rate. Third, the machine-learned model 500 can be trained 510 on a set of impressions different from a plurality of impressions used for generating the set of resolved impressions. In this way, overlap between the training 510 and regression can be avoided.

### Operations for Estimating Unique Reach Based on Percentage Model

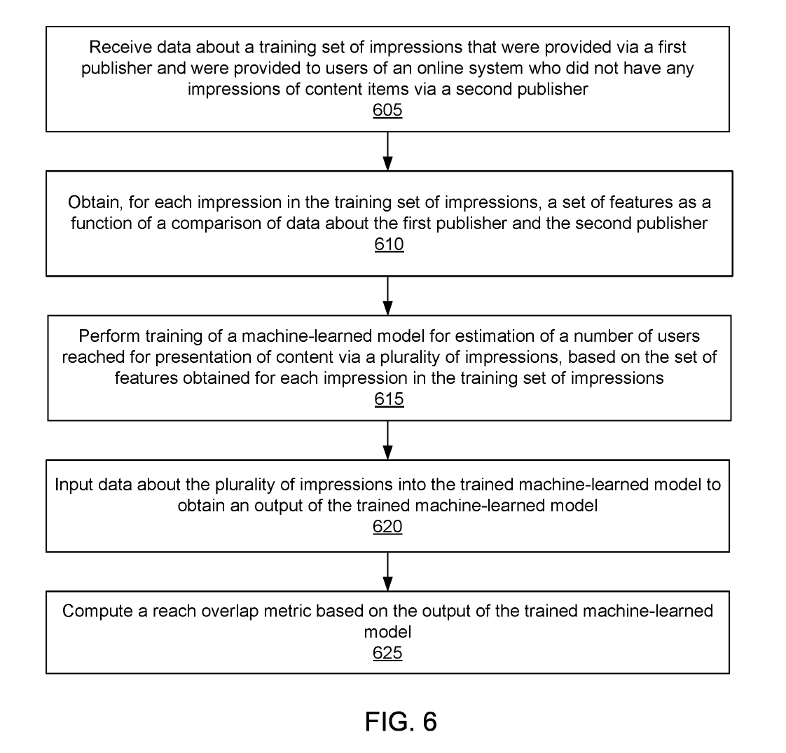

FIG. 6 is a flowchart of one embodiment of a method for estimation of unique reach based on the machine-learned model 500 shown in FIG. 5. In various embodiments, the steps described in conjunction with FIG. 6 may be performed in different orders than the order described in conjunction with FIG. 6. Additionally, the method may include different and/or additional steps than those described in conjunction with FIG. 6 in some embodiments.

The online system 140 receives 605 data about a training set of impressions that were provided via a first publisher and were provided to users of an online system who did not have any impressions of content items via a second publisher. In some embodiments, the training set of impressions comprises resolved impressions based on historical data that may be provided to the online system 140 via some other system entity different from the online system 140.

The online system 140 obtains 610, for each impression in the training set of impressions, a set of features as a function of a comparison of historical data about the first publisher and historical data about the second publisher. In some embodiments, the set of features obtained 610 may comprise the features 520 utilized for training 510 of the machine-learned model 500. The historical data about the first and second publishers user to obtain 610 the set of features for each training impression can be selected from the group consisting of: aggregated statistics on a set of impressions related to the first publisher and the second publisher, statistics of different users of the first publisher and the second publisher, information about different cookies between the first publisher and the second publisher, a percentage of distinct IP addresses of users reached by the first publisher and by the second publisher, and a percentage of same IP addresses of users reached by both the first and the second publishers.

The online system 140 performs 615 the training 510 of the machine-learned model 500 based on the set of features 520 obtained for each impression in the training set of impressions. In an embodiment, the model training 510 of the machine-learned model 500 is based on at least one of: the linear regression algorithm, or one or more other regression techniques. In another embodiment, the online system 140 performs 615 the training 510 of the machine-learned model 500 based on a metric (e.g., ground truth) obtained using the training set of impressions (e.g., resolved impressions). To de-bias historical data, the online system 140 may further perform de-synchronization of the training set of impressions, and perform 615 the training 510 of the machine-learned model 500 based on the desynchronized set of impressions.

In some embodiments, the online system 140 inputs 620 data about a plurality of impressions related to displaying content via one or more publishers (e.g., impressions data 530) into the trained machine-learned model 500 to obtain the output 540 of the trained machine-learned model 500. The output 540 comprises information about reach metrics for a given publisher.

The online system 140 computes 625 a reach overlap metric based on the output 540 of the trained machine-learned model 500. In an embodiment, the online system 140 computes 625 a percentage of users (e.g., percentage output 540) that have been reached only the first publisher. In another embodiment, the online system 140 multiplies, as given by equation (3), the computed percentage of users reached only by the first publisher with an estimated total number of users reached by the first publisher to compute 625 a number of users reached only by the first publisher, i.e., to compute 625 unique reach metric for the first publisher. In yet another embodiment, the online system 140 computes 625 an estimated number of common users reached by the first publisher and the second publisher (i.e., reach overlap), based on the computed percentage of users reached only by the first publisher and an estimated total number of users reached by the first publisher. The total number of users reached by the first publisher, i.e., reach of the first publisher, can be estimated based on the reach and frequency prediction model.

In some embodiments, the online system 140 receives, from other system environment, the machine-learned model 500 for estimation of unique reach and reach overlap metrics. The machine-learned model 500 was trained, by the other system environment, based on a set of features obtained for each impression in a training set of impressions as a function of a comparison of data about a first publisher and data about a second publisher. The training set of impressions was provided via the first publisher and was provided to users of an online system who did not have any impressions of content items via the second publisher. The online system 140 inputs data related to a plurality of impressions into the trained machine-learned model 500 to obtain output 540 of the trained machine-learned model 500. The online system 140 computes a reach overlap metric (or a unique reach metric) based on output 540 of the trained machine-learned model 500 received from the other system environment.

A use case of the unique reach metric determined based on the methods presented herein is to help content providers to determine which publishers to use for maximizing public awareness regarding provided content. The determined unique reach metric for a given publisher can be employed for decision about bidding for embodiments where a content provider is paying the publisher to present the content. In an illustrative embodiment, a musician wants to reach as large public audience as possible with a new song. Thus, the musician as a content provider uses unique reach metrics for multiple publishers to determine which publisher would bring the most new listeners (e.g., online users). Optionally, the musician or the content provider may use the unique reach metrics for the multiple publishers to make a decision about whether and how much to pay the publisher(s) to host the new song for downloading by new listeners (online users).

### Performance Results for Different Models for Estimation of Unique Reach and Reach Overlap

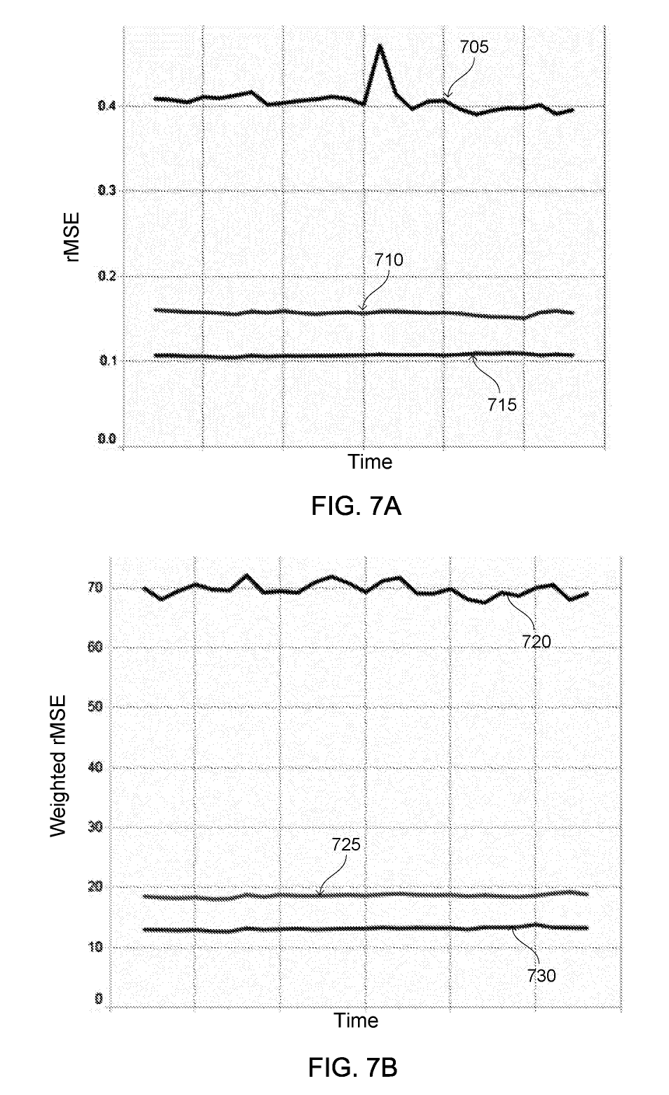

FIGS. 7A and 7B illustrate graphs of reach overlap performance for different models, in accordance with an embodiment. The models evaluated in FIGS. 7A and 7B are: the traditional production model defined by equation (1), see plots 705 and 720 in FIGS. 7A and 7B, respectively; the inclusive-exclusive model defined by equation (2), see plots 710 and 725 in FIGS. 7A and 7B, respectively; and the machine-learned model 500 illustrated in FIG. 5 and applied in equation (3) for obtaining the unique reach metric, see plots 715 and 730 in FIGS. 7A and 7B, respectively. The graphs in FIGS. 7A and 7B show an average root mean square error (rMSE) for unique reach estimate when different estimation models are applied during evaluation campaigns on daily basis which provides a daily trend. If the rMSE is lower, then the corresponding model for estimation of unique reach is more accurate. If, for example, rMSE is zero, then the corresponding model for estimation of unique reach would be perfectly accurate, i.e., without an estimation error.

In particular, FIG. 7A shows rMSE for unique reach estimate by a publisher when different aforementioned estimation models are applied, wherein rMSE can be calculated as an error difference between a percentage of true unique reach for a publisher and a percentage of unique reach predicted by a corresponding one of the aforementioned estimation models, i.e., rMSE of an estimation model shown in FIG. 7A can be obtained as:

$$\sqrt{{\sum }_{across all publisher slices} {( \begin{matrix}\% True Unique Reach - \\ \% Predicted Unique Reach\end{matrix} )}^{2}} . \qquad ( 5 )$$

It can be observed from FIG. 7A that, when the machine-learned model 500 illustrated in FIG. 5 is applied for estimating the percentage of unique reach in equation (5), rMSE is reduced by a factor of approximately 75% relative to the current production model given by equation (1), i.e., rMSE is reduced from approximately 0.4 to approximately 0.1 (see plot 715 versus plot 705 in FIG. 7A).

The graphs shown in FIG. 7B represent weighted rMSE of unique reach over time for different aforementioned models for estimation of unique reach. In particular, FIG. 7B illustrates rMSE of unique reach over time weighted by a total impression volume. It can be observed from FIG. 7B that improvement in estimation of the unique reach metric when the machine-learned model 500 is applied is large relative to the current production model (see plot 730 versus plot 720 in FIG. 7B).

### SUMMARY

Disclosed embodiments include methods for generating models for estimation of unique reach and reach overlap. The methods disclosed herein have several distinctive features. First, estimation of reach overlap metric can be built on top of estimation of reach metrics. Second, a model for estimation of unique reach metric can be efficiently built to provide as an output an estimated percentage of unique reach. Third, various input features can be utilized for building the model that predicts the percentage of unique reach. Fourth, the model that predicts the percentage of unique reach can be efficiently trained to provide high accuracy estimation.

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving data about a training set of impressions that were provided via a first publisher and were provided to users of an online system who did not have any impressions of content items via a second publisher;
obtaining, for each impression in the training set of impressions, a set of features as a function of a comparison of data about the first publisher and the second publisher;
training a machine-learned model for estimation of a number of users reached for presentation of content via a plurality of impressions, based on the set of features obtained for each impression in the training set of impressions;
inputting data about the plurality of impressions into the trained machine-learned model to obtain an output of the trained machine-learned model; and
computing a reach overlap metric based on the output of the trained machine-learned model.

2. The method of claim 1, wherein the data about the first publisher and the second publisher used for obtaining the set of features are selected from the group consisting of: aggregated statistics on impressions related to the first publisher and the second publisher, statistics of different users of the first publisher and the second publisher, information about different cookies between the first publisher and the second publisher, a percentage of distinct Internet Protocol (IP) addresses of users reached by the first publisher and by the second publisher, and a percentage of same IP addresses of users reached by both the first and the second publishers.

3. The method of claim 1, wherein training the machine-learned model for estimation of the number of users reached for presentation of the content comprises:
training the machine-learned model for estimation of a percentage of users reached only by the first publisher for presentation of the content.

4. The method of claim 1, wherein computing the reach overlap metric based on the output of the trained machine-learned model comprises:
computing a percentage of users reached only by the first publisher for presentation of the content.

5. The method of claim 4, further comprising:
multiplying the computed percentage of users reached only by the first publisher with an estimated total number of users reached by the first publisher to compute a number of users reached only by the first publisher for presentation of the content.

6. The method of claim 4, further comprising:
computing an estimated number of common users reached by the first publisher and the second publisher for presentation of the content, based on the computed percentage of users reached only by the first publisher and an estimated total number of users reached by the first publisher.

7. The method of claim 1, wherein computing the reach overlap metric based on the output of the trained machine-learned model comprises:
computing a number of users reached only by the first publisher for presentation of the content.

8. The method of claim 1, wherein training the machine-learned model for estimation of the number of users reached for presentation of the content comprises:
training the machine-learned model based on at least one of the linear regression algorithm, or one or more other regression techniques.

9. The method of claim 1, wherein training the machine-learned model for estimation of the number of users reached for presentation of the content comprises:
training the machine-learned model based on a metric obtained using the training set of impressions.

10. The method of claim 1, further comprising:
performing de-synchronization of the training set of impressions; and
training the machine-learned model for estimation of the number of users reached for presentation of the content, based on the desynchronized set of impressions.

11. The method of claim 1, comprising:
estimating, based on the trained machine-learned model, a first number of users reached by the first publisher for presentation of the content;
estimating, based on the trained machine-learned model, a second number of users reached by the second publisher for presentation of the content;
estimating, based on the trained machine-learned model, a third number of users reached by a publisher that comprises the first publisher and the second publisher for presentation of the content;
computing an estimated number of common users reached by the first publisher and the second publisher for presentation of the content, based on the estimated first number of users, the estimated second number of users and the estimated third number of users.

12. A method comprising:
receiving a machine-learned model for estimation of a number of users reached for presentation of content via a plurality of impressions,
the machine-learned model being trained based on a set of features obtained for each impression in a training set of impressions as a function of a comparison of data about a first publisher and a second publisher,
the training set of impressions were provided via the first publisher and were provided to users of an online system who did not have any impressions of content items via the second publisher;
inputting data about the plurality of impressions into the trained machine-learned model to obtain an output of the trained machine-learned model; and
computing a reach overlap metric based on the output of the trained machine-learned model.

13. The method of claim 12, wherein computing the reach overlap metric based on the output of the trained machine-learned model comprises:
computing a percentage of users reached only by the first publisher for presentation of the content.

14. A computer program product comprising a computer-readable storage medium having instructions encoded thereon that, when executed by a processor, cause the processor to:
receive data about a training set of impressions that were provided via a first publisher and were provided to users of an online system who did not have any impressions of content items via a second publisher;
obtain, for each impression in the training set of impressions, a set of features as a function of a comparison of data about the first publisher and data about the second publisher;
train a machine-learned model for estimation of a number of users reached for presentation of content via a plurality of impressions, based on the set of features obtained for each impression in the training set of impressions;
input data about the plurality of impressions into the trained machine-learned model to obtain an output of the trained machine-learned model; and
compute a reach overlap metric based on the output of the trained machine-learned model.

15. The computer program product of claim 14, wherein train the machine-learned model for estimation of the number of users reached for presentation of the content comprises:
train the machine-learned model for estimation of a percentage of users reached only by the first publisher for presentation of the content.

16. The computer program product of claim 14, wherein compute the reach overlap metric based on the output of the trained machine-learned model comprises:
compute a percentage of users reached only by the first publisher for presentation of the content.

17. The computer program product of claim 16, wherein the instructions further cause the processor to:
multiply the computed percentage of users reached only by the first publisher with an estimated total number of users reached by the first publisher to compute a number of users reached only by the first publisher for presentation of the content.

18. The computer program product of claim 16, wherein the instructions further cause the processor to:
compute an estimated number of common users reached by the first publisher and the second publisher for presentation of the content, based on the computed percentage of users reached only by the first publisher and an estimated total number of users reached by the first publisher.

19. The computer program product of claim 14, wherein compute the reach overlap metric based on the output of the trained machine-learned model comprises:
compute a number of users reached only by the first publisher for presentation of the content.

20. The computer program product of claim 14, wherein train the machine-learned model for estimation of the number of users reached for presentation of the content comprises:
train the machine-learned model based on at least one of the linear regression algorithm, or one or more other regression techniques.
